(19) United States
(12) Patent Application Publication
(10) Pub. No.: US 2012/0186539 A1
(43) Pub. Date: Jul. 26, 2012

(54) Pet leash system

(76) Inventor: Kenny A. Johnston, Riverside, CA (US)

(21) Appl. No.: 12/800,951

(22) Filed: May 26, 2010

Related U.S. Application Data
(60) Provisional application No. 61/268,783, filed on Jun. 16, 2009.

(51) Int. Cl. A01K 27/00

(52) U.S. Cl. 119/796

(57) ABSTRACT

A pet leash system for holding a pet in a controlled manner is provided. The pet leash system comprises a leash housing and a length of leash retractable into the leash housing. A dispenser compartment is mounted to the leash housing. A plurality of waste collection bags is storable in the dispenser compartment. A storage pouch is mounted on the leash housing. A clip mechanism mounted to the leash housing releasably secures the leash housing to an object.

The present application claims the benefit of priority of pending provisional patent application Ser. No. 61/268,783, filed on Jun. 16, 2009, entitled “Hands Free Leash Kit”.

### BACKGROUND OF THE INVENTION

1. Field of the Invention

This invention relates generally to a pet leash system and, more particularly, the invention relates to a pet leash system providing a hands free leash kit having an integrated spring-loaded belt clip for use in securing the pet leash system to the person, thus affording a hands free means of controlling one's pet.

2. Description of the Prior Art

A favorite pastime enjoyed by many dog owners, as well as their pets, is taking a leisurely or fast paced walk. Breathing in the fresh air, stretching the body with some light exercise, and enjoying the sites and sounds of new surroundings, taking an outdoor walk can be a revitalizing experience for both the animal and their owner. Typically, most dogs love going for walks. Not surprisingly, many dog owners report that their pets instinctively run for the door as soon as they see that their master's have grabbed their leash.

When walking their animal, many pet owners often multitask, talking on their cellular telephone or even enjoying a steamy cup of hot coffee, all while they stroll with their pet. Unfortunately, trying to control a spirited, leashed animal with one hand, while holding a piping cup of coffee, a newspaper or cell phone with the other, can be difficult. Often resulting in the leash becoming tangled, or the owner dropping the item they are holding onto, multitasking while walking a dog can sometimes be a daunting venture.

Another problem encountered by pet owners when walking their animal has to do with storing items necessary on the go. When taking a dog for a walk, most consumers carry one or more plastic bags for disposing dog waste. Bulging from coat and pant pockets, transporting the bags necessary for walking with one's dog can detract from the overall fun of this activity.

### SUMMARY

The present invention is a pet leash system for holding a pet in a controlled manner is provided. The pet leash system comprises a leash housing and a length of leash retractable into the leash housing. A dispenser compartment is mounted to the leash housing. A plurality of waste collection bags is storable in the dispenser compartment. A storage pouch is mounted on the leash housing. A clip mechanism mounted to the leash housing releasably secures the leash housing to an object.

In addition, the present invention includes a method for holding a pet in a controlled manner. The method comprises providing a leash housing, retracting a length of leash into the leash housing, mounting a dispenser compartment to the leash housing, storing a plurality of waste collection bags in the dispenser compartment, mounting a storage pouch on the leash housing, and releasably securing the leash housing to an object.

The present invention further includes pet leash system for holding a pet in a controlled manner. The pet leash system comprises a leash housing with a handle formed on the leash housing and a length of leash retractable into the leash housing. A lock/release mechanism controls the coiled leash housed within the leash housing. A dispenser compartment is mounted to the leash housing with a plurality of waste collection bags storable in the dispenser compartment. A storage pouch is mounted on the leash housing together with a pepper spray holder and a flashlight. A spring-loaded belt clip is mounted on the leash housing substantially opposite the storage pouch wherein the belt clip is sized and shaped for being releasably securable to a waistband or a belt loop.

### BRIEF DESCRIPTION OF THE DRAWINGS

FIG. 1 is a perspective view illustrating a pet leash system, constructed in accordance with the present invention;

FIG. 2 is another perspective view illustrating the pet leash system, constructed in accordance with the present invention; and

FIG. 3 is still another perspective view illustrating the pet leash system, constructed in accordance with the present invention.

### DETAILED DESCRIPTION OF THE PREFERRED EMBODIMENTS

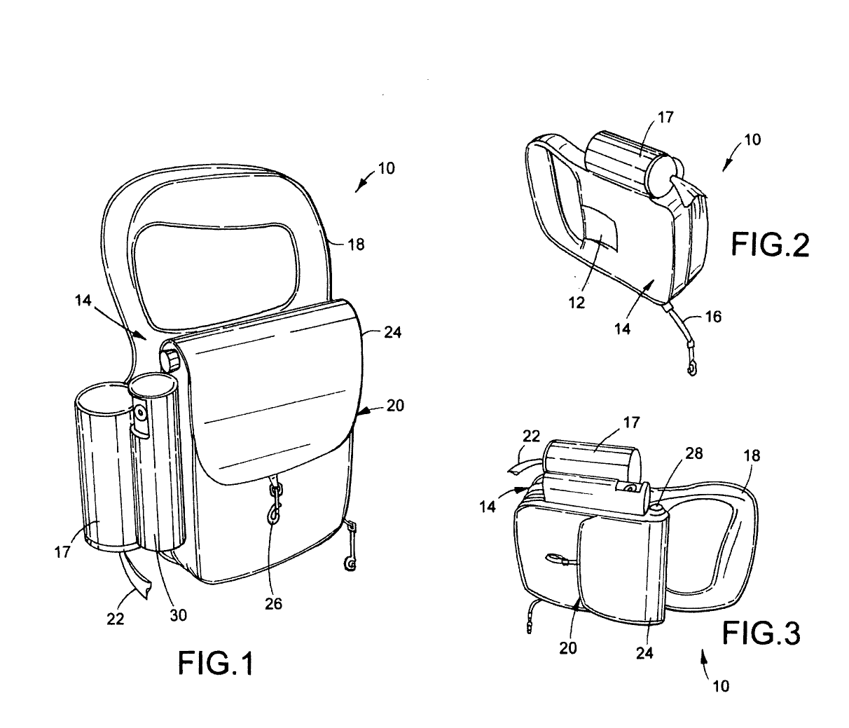

As illustrated in FIGS. 1-3, the present invention is a pet leash system, indicated generally at 10, for holding a pet in a controlled manner. As will be described in further detail below, the pet leash system 10 of the present invention has an integrated spring-loaded belt clip 12 for use in securing the pet leash system 10 to the person, thus affording a hands free means of controlling one's pet. Pet, as defined herein, can be any type of household pet or other animal depending on the desires of the user.

The pet leash system 10 of the present invention has a leash housing 14 holding a length of leash 16. The leash 16 of the pet leash system 10 is preferably a retractable leash 16 which automatically retracts into the leash housing 14 upon release of any pressure on the leash 16. When the leash 16 retracts into the leash housing 14, the leash 16 is stored within the leash housing 14 in a coiled manner.

As a further consideration, the pet leash system 10 of the present invention features a handle 18 formed at the proximal end of the leash housing 14 or at any other position on the leash housing 14. Comfortably positioned directly above or adjacent the handle 18 is a simple slide release mechanism for controlling the coiled leash 16 housed within the leash housing 14, “dispensing” the leash 16 from a small opening positioned at the top distal end or other convenient location of the leash housing 16, and if desired, releasably locking the leash 16 in place to restrain the animal. Produced in a variety of lengths, the retractable leash 16 can be manufactured of nylon or similar durable material and feature a standard snap-release clip, designed to secure the leash 16 to the pet collar.

The leash housing 14 of the pet leash system 10 of the present invention is preferably constructed of a durable plastic material generally rectangular in shape with soft rounded edges. A standard version of the leash housing 14 measures approximately six (6″) inches in length, approximately four (4″) inches in width, and approximately one (1″) inch in total depth while smaller and larger versions appropriate for toy, small, and large size dog breeds are also available.

In addition, the pet leash system 10 of the present invention has an integrated dispenser compartment 17 positioned at the base of the leash housing 14 inside of which a number of waste collection bags 22 can be neatly stored and easily accessed. The dispenser compartment 17 can be constructed such that a roll of waste collection bags 22 can be inserted through one end and then dispensed one at a time through the other end. Preferably, the dispenser compartment 17 is a circular-shaped storage chamber positioned on the end of the leash housing 14 substantially opposite the leash 16. Featuring a hinged access cap with a circular or slotted dispenser through which collection bags 22 are retrieved, the dispenser compartment 17 is sized appropriately to store at least several waste collection bags 22. The easy access to the waste collection bags 22 allows the responsible pet owner to pick up their pet's waste and dispose of the pet's waste in a proper receptacle.

The pet leash system 10 of the present invention further includes an expandable storage pouch 18 mounted on the leash housing 14 for use in storing collected waste bags 22 prior to disposal in a proper receptacle. An ample flap 24 covering encompasses the top of the storage pouch 20 serving to contain the filled waste bag 22 and any lingering odors within. While the expandable storage pouch 20 has been described as holding used waste bags 22, it is within the scope of the present invention to use the storage pouch 20 to store other items including keys, cell phones, wallet, etc. A key ring 26 can be secured to the expandable pouch 20 for holding a user's keys or other items while walking and/or exercising their pet.

As briefly noted above, the pet leash system 10 of the present invention includes the spring-loaded belt clip 12 located on the underside of the leash housing 14 opposite the expandable storage pouch 20. A sturdy, heavy-duty plastic spring-loaded belt clip 12 having a plastic casing, the belt clip 12 can be easily secured to the user's waistband or a belt loop allowing the user to control their animal hands free. The belt clip 12 is spring-loaded in that the belt clip 12 is biased to a closed position thereby firmly grasping the user's waistband or belt loop inhibiting the pet leash system 10 from becoming accidentally or inadvertently dislodged therefrom.

The pet leash system 10 of the present invention can further include a flashlight 28 releasably mounted to either the leash housing 14 or the expandable storage pouch 20. The flashlight 28 can be used either secured to the pet leash system 10 to view the upcoming sidewalk, road, or trail, or can be removed for use separate from the pet leash system 10. Also included can be a holder 30 for a can or bottle of pepper spray or the like. The pepper spray can be especially useful for that user walking their pets where other domesticated or wild animals live or in high crime areas.

The manner of use of the pet leash system 10 of the present invention will now be described. It will be understood by those skilled in the art that the manner of use of the pet leash system 10 described herein is merely one method of use and other methods of use of the pet leash system 10 are within the scope of the present invention.

Use of the pet leash system 10 of the present invention is very simple and straightforward. First, the user fills the integrated storage compartment 17 with a roll of collection bags 22 for use when walking a dog. Once the compartment 17 had been filled, the user secures the animal's leash about their collar or harness and the owner and animal then sets out for their walk. While strolling, the owner might choose to secure the unit to their waistband utilizing the spring-loaded clip fastener 12 to enjoy hands free control over their pet. In this manner, the owner enjoys the hands-free convenience of the leash kit, while the dog freely roams about either side, in front or behind their owner, securely tethered to this unique waist clamp 12. As needed, the user retrieves waste collection bags 22 from the integrated dispenser 17, placing the collected waste in the integrated storage compartment 20 for transport to the nearest trash receptacle. Returning safely home, the pet owner easily removes the pet leash system 10 by unhooking the unit from the dog's collar, storing the device away until again needed.

The pet leash system 10 of the present invention affords pet owners, and their animals, several benefits and advantages. Foremost, the pet leash system 10 offers pet lovers a simple, hands-free means of walking their pet. Users will appreciate that simply by securing the pet leash system's 10 integrated belt clamp 12 about their waist they can enjoy a leisurely stroll with their pet while keeping their hands free to multitask. Whether chatting on the phone with a friend or enjoying an icy cold beverage, use of the pet leash system 10 allows the pet owner to perform these activities, all while safely walking their animal. Eliminating the need to continuously pass a leash back and forth between the hands, simply in order to alleviate the strain associated with holding the leash or to satisfy the directional demands of the animal, the pet leash system 10 enables the dog owner to walk their pet in comfort and with ease. Further, pets secured to the pet leash system 10 enjoy the freedom that this unique waist clamp 17 allows. Enabling the animal free range to roam on either side, behind or in front of the owner, the pet leash system 10 proves a favorite commodity of both the owner and the pet. Versatile, the pet leash system 10 kit is ideal for use with virtually any size pet.

Another important advantage to the pet leash system 10 of the present invention is found in this unique pet leash system's 10 storage capabilities. Simply stated, the pet leash system 10 provides users a simple and efficient means of transporting the waste collection bags 22 necessary when taking a pet for a walk, as well as transporting these filled bags prior to disposal. A practical alternative to loading down pockets with these bags, or attempting to carry the collection bags 22 along with the leash 16 by hand, the pet leash system 10 allows users to transport and access these goods in a quick and comfortable manner. Not just for pet owners, the pet leash system 10 also proves an invaluable aid to professional pet caretakers, allowing them to keep themselves and their charges safe from harm.

Versatile and unique, the pet leash system 10 of the present invention offers dog owners a comfortable, hands-free means of walking their pet. Lightweight and easily donned, the pet leash system 10 proves a favorite commodity of any pet lover. Featuring an integrated bag dispenser 17 and ample storage 20 for these collection bags 22 once they are filled, the pet leash system 10 also enables pet owners to easily transport goods needed when walking one's pet.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A pet leash system for holding a pet in a controlled manner, the pet leash system comprising:
a leash housing;
a length of leash retractable into the leash housing;
a dispenser compartment mounted to the leash housing;
a plurality of waste collection bags storable in the dispenser compartment;
a storage pouch mounted on the leash housing; and
clip means mounted to the leash housing for releasably securing the leash housing to an object.

2. The pet leash system of claim 1 and further comprising:
a handle formed on the leash housing.

3. The pet leash system of claim 1 and further comprising:
a lock/release mechanism for controlling the coiled leash housed within the leash housing.

4. The pet leash system of claim 1 wherein the dispenser compartment is a substantially circular-shaped storage chamber positioned on an end of the leash housing substantially opposite the leash.

5. The pet leash system of claim 4 wherein the dispenser compartment has a hinged access cap with a dispenser aperture through which waste collection bags are retrieved.

6. The pet leash system of claim 1 wherein the storage pouch is an expandable storage pouch having a flap for selectively covering the storage pouch.

7. The pet leash system of claim 1 wherein the clip means is a spring-loaded belt clip mounted on the leash housing substantially opposite the storage pouch.

8. The pet leash system of claim 7 wherein the belt clip is sized and shaped for being releasably securable to a waistband or a belt loop.

9. A method for holding a pet in a controlled manner, the method comprising:
providing a leash housing;
retracting a length of leash into the leash housing;
mounting a dispenser compartment to the leash housing;
storing a plurality of waste collection bags in the dispenser compartment;
mounting a storage pouch on the leash housing; and
releasably securing the leash housing to an object.

10. The method of claim 9 and further comprising:
forming a handle on the leash housing.

11. The method of claim 9 and further comprising:
mounting a lock/release mechanism on the leash housing.

12. The method of claim 9 wherein the dispenser compartment is a substantially circular-shaped storage chamber positioned on an end of the leash housing substantially opposite the leash.

13. The method of claim 12 and further comprising:
mounting a hinged access cap on the dispenser compartment;
forming a dispenser aperture in the dispenser compartment; and
retrieving waste collection bags through the dispenser aperture.

14. The method of claim 9 wherein the storage pouch is an expandable storage pouch having a flap for selectively covering the storage pouch.

15. The method of claim 9 and further comprising:
mounting a spring-loaded belt clip on the leash housing substantially opposite the storage pouch.

16. The method of claim 15 and further comprising:
releasably securing the belt clip to a waistband or a belt loop.

17. A pet leash system for holding a pet in a controlled manner, the pet leash system comprising:
a leash housing;
a handle formed on the leash housing;
a length of leash retractable into the leash housing;
a lock/release mechanism for controlling the coiled leash housed within the leash housing;
a dispenser compartment mounted to the leash housing;
a plurality of waste collection bags storable in the dispenser compartment;
a storage pouch mounted on the leash housing;
a pepper spray holder mounted to the leash housing;
a flashlight mounted to the leash housing; and
a spring-loaded belt clip mounted on the leash housing substantially opposite the storage pouch;
wherein the belt clip is sized and shaped for being releasably securable to a waistband or a belt loop.

18. The pet leash system of claim 17 wherein the dispenser compartment is a substantially circular-shaped storage chamber positioned on an end of the leash housing substantially opposite the leash.

19. The pet leash system of claim 18 wherein the dispenser compartment has a hinged access cap with a dispenser aperture through which waste collection bags are retrieved.

20. The pet leash system of claim 17 wherein the storage pouch is an expandable storage pouch having a flap for selectively covering the storage pouch.
